(19) United States
(12) Patent Application Publication
(10) Pub. No.: US 2019/0316006 A1
(43) Pub. Date: Oct. 17, 2019

(54) FIBER MATRIX ADHESIVE TAPE

(71) Applicant: A+ Composites GmbH, Weselberg (DE)

(72) Inventor: Markus Brzeski, Weilerbach (DE)

(21) Appl. No.: 16/381,746

(22) Filed: Apr. 11, 2019

(30) Foreign Application Priority Data
Apr. 11, 2018 (DE) 202018101967.8

(51) Int. Cl. C09J 7/20; C09J 7/35

(52) U.S. Cl. CPC C09J 7/20; C09J 7/35

(57) ABSTRACT

Adhesive tape for attaching, covering and mechanically reinforcing surfaces with a carrier layer and an adhesive layer adhering thereto, wherein the carrier layer is composed of a matrix material in which fibers are embedded.

### CROSS-REFERENCE TO RELATED APPLICATIONS

This patent application claims priority to German utility patent application number 20 2018 101 967.8 filed Apr. 11, 2018 and titled “Fiber Matrix Adhesive Tape”. The subject matter of patent application number 20 2018 101 967.8 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND

Glass fiber-reinforced or carbon fiber-reinforced adhesive tapes and foils with various instant adhesive components are commercially available. Such fiber-reinforced adhesive tapes are in principle “normal” adhesive tapes having a carrier layer which is constituted by a fiber fabric. Usually, the adhesive films of such adhesive tapes are somewhat stronger. Frequently, the fibers are designed as a fabric sheet and the adhesive layer forms a separate layer on the fabric sheet. Adhesion of the adhesive tape is therefore confined due to the adhesion of the adhesive layer on the fabric sheet, for which reason adhesive tapes of this type can only be used in limited fields of application.

For example, a glass-fiber reinforced adhesive tape in the form of an aluminum-glass-fabric adhesive tape for attachment, covering and decorating is well-known on the market. This aluminum-glass-fabric adhesive tape is a laminate composed of aluminum foil and glass fabric that carries an adhesive layer composed of a transparent silicone adhesive. The glass-fiber fabric creates high transverse and longitudinal tear strength. The aluminum foil has a radiation and heat reflective effect, so that it can be used in an environment with a temperature of up to 1000° C.

Another product well-known on the market is fiber-reinforced adhesive tape for the closing of packaging. This adhesive tape makes it possible to realize high tear strength as a result of polyester threads included in the sealed layer.

Furthermore, prior art discloses a similar solution in DE 20 2014 011 009 U1, in which a fiber layer is applied to a thermosetting adhesive foil based on epoxy resin. An adhesive layer is applied to the fiber layer. The fiber layer is batt-shaped, especially as a woven, meshed or tangled batt. In the case of the adhesive foil, the uncured foil is located on one or both sides of the fiber carrier.

The disadvantage of these adhesive tapes or adhesive foils known from prior art is that the fabric fiber and the adhesive layer adhere insufficiently to each other and the adhesive tape can therefore only be used for limited application purposes. Furthermore, adhesive tapes known from prior art have the disadvantage that the carrier layer has insufficient dimensional stability, which renders adhesive tapes of this type unsuitable for lending additional mechanical stability to components, to which they adhere, for example against bending stress.

Furthermore, from prior art disclosed in DE 10 2006 023 935 A1 an adhesive tape reinforced with filaments is known. The problem afflicted with this adhesive tape is that the strengths are strongly limited due to the thin carrier layer. In this regard, only very thin and mechanically weak filaments can be used. In the case of carrier layers of this type it cannot be ensured that the filament is completely embedded in the matrix material. This also applies with regard to the low fiber contents disclosed therein.

### SUMMARY

The invention relates an adhesive tape for attachment to surfaces, in particular a fiber-matrix adhesive tape, according to the independent claim.

It is the object of the invention to provide an adhesive tape that overcomes the disadvantages known from prior art and, in particular can be used for a plurality of application purposes.

The object is achieved by an adhesive tape according to the independent claim. Advantageous embodiments constitute the subject-matter of the respective subclaims.

The invention comprises an adhesive tape with a carrier layer and an adhesive layer adhering thereto. The carrier layer is composed of a matrix material in which fibers are embedded. In the carrier layer designed in this way, the fibers are completely embedded in the matrix material so that the adhesive layer only comes into contact with the matrix material rather than with the fibers. The fibers reinforce the matrix material and include, for example, fibers made of carbon, glass, aramid or plastic. The dimensional stability of the carrier layer also makes it possible to provide components, to which the tapes adhere to, with additional stability against bending stress. In this way, a versatile adhesive tape is realized.

### BRIEF DESCRIPTION OF THE DRAWINGS

FIG. 1 shows a perspective lateral view of an exemplary embodiment of the inventive adhesive tape;

FIG. 2 shows a sectional view of the adhesive tape according to FIG. 1;

FIG. 3 shows a schematic representation of a manufacturing process for an adhesive tape according to FIG. 1;

FIG. 4 shows a schematic representation of an alternative manufacturing process for an adhesive tape according to FIG. 1;

FIG. 5 shows an application example for an adhesive tape according to FIG. 1 on a medical support; and

FIG. 6 shows another application example for an adhesive tape according to FIG. 1 in the form of an attachment to a transport box.

### DETAILED DESCRIPTION

According to one advantage aspect of the invention the fibers are completely embedded in the matrix material in such a manner that on at least one lateral surface the fibers are entirely located under the surface of the matrix material of the carrier layer. Advantageously, the fibers are completely embedded in the matrix material in such a manner that any lateral surface of the carrier layer is not penetrated by the fibers. The lateral surfaces are the surfaces formed in the longitudinal direction on a side of the matrix material, i.e. not the front surfaces. The matrix material thus forms a smooth surface on the lateral surfaces to which the adhesive layer adheres uniformly and over the entire surface.

A technically preferred aspect of the invention provides that the fibers are arranged unidirectionally in the matrix material. In this regard, the fibers are either designed continuous or discontinuous. The fibers arranged in this way make it possible to absorb forces in the longitudinal direction of the adhesive tape, for example when the adhesive tape is adhered to a component to be reinforced. In this context, short pieces (chips or patches) can also be layered.

Another preferred aspect provides that the fibers have a fiber volume content of 15% to 80% based on the volume of the carrier material. It is particularly preferred that the fibers have a fiber volume content of 20% to 70%. The high fiber content allows the absorption of large forces, but at the same time is kept sufficiently low so that the fibers are surely completely enclosed by the matrix material.

Advantageously, the fibers are designed so as to exhibit a modulus of elasticity in the range from 10 GPa to 1000 GPa.

The fibers are preferably designed so as to have a tensile strength in the range from 50 MPa to 10000 MPa.

It is also preferred that the matrix material comprises voids and that the volume fraction of the voids is 10% at a maximum. The low volume fraction of the voids in the matrix material ensures high strength and thus little flexibility of the carrier layer.

It is also preferred that the matrix material is a thermoplastic, a thermoset, an elastomer or a thermoplastic elastomer. Mixtures thereof can also be employed for the matrix material.

According to a particularly preferred aspect, the carrier layer has a thickness in the range of 0.05 mm to 7 mm. In particular, in the range from 0.1 mm to 0.5 mm, the advantages regarding reinforcement of other components can be realized. Advantageously, the carrier layer has a width of 6 mm to 2000 mm.

Another particularly preferred aspect provides that the adhesive layer has a thickness in the range of 0.01 mm to 2 mm. The thickness of the adhesive layer can be varied depending on the adhesive component used and the application purpose. Particle and binder powders with respective hardeners or resin components can also be used.

Advantageously, the adhesive layer is selected from the group consisting of polymerization, polyaddition and polycondensation adhesives, solvent-containing adhesives, dispersion adhesives, hot-melt adhesives, contact adhesives or plastisols. In particular, epoxy or polyurethane adhesives, phenol-formaldehyde resin adhesives or silicones, methyl-methacrylate adhesives, cyanoacrylate adhesives, anaerobic curing adhesives or combinations thereof are used.

Preferably, the adhesive layer is selected form the group consisting of thermoplastic hot-melt adhesives, such as ethylene-vinyl-acetate copolymers (EVA), thermoplastic rubbers (TK), synthetic rubbers (SBS/SIS), polyester (PET), polyester (PES), polyamides (PA), polyolefins (PO), amorphous poly-α-olefins (APAO), from the group consisting of reactive or encapsulated hot-melt adhesives (e.g. by UV, humidity, temperature), such as polyurethane hot-melt adhesives (PUR), polyolefin hot-melt adhesives (POR), acrylates, silane-terminated hot-melt adhesives, epoxies with thermoplastic character, silicones with thermoplastic character as well as the group consisting of hot-melt adhesives or elastomers with permanent adhesiveness, such as ethylene-vinyl-acetate copolymers (EVA), thermoplastic rubbers (TK), synthetic rubbers (SBS/SIS), polyester (PET), polyester (PES), polyamides (PA), polyolefins (PO), amorphous poly-α-olefins (APAO) or combinations of these groups.

Preferably, the adhesive layer is designed to be thermosetting or cold-setting. Both variants can each be used for special application purposes. For example, the thermosetting adhesive layer can be suitably used in automated processes. The cold-setting adhesive layer is advantageous in applications where a heating device is not available.

In the following, the invention will be explained in more detail using the examples shown in the attached figures.

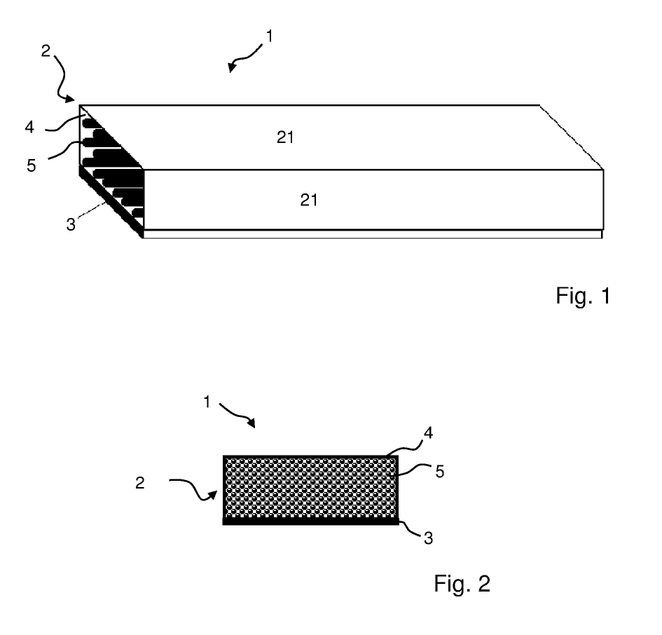

FIG. 1 shows a section of an adhesive tape 1 according to the invention. The adhesive tape 1 has a carrier layer 2 disposed on the top thereof, to which an adhesive layer 3 adheres to from below.

The carrier layer 2 is composed of a matrix material 4 in which fibers 5 are embedded. The thickness of the carrier layer 2 in the example shown is in the range of 0.1 mm to 7 mm.

Advantageously, the matrix material 4 is composed of a thermoplastic, a thermoset, an elastomer or mixtures thereof. The matrix material 4 shown has a volume fraction of the air voids of less than 10%, whereby the air voids cannot be represented explicitly.

The fibers 5 are completely embedded in the matrix material 4 in such a manner that they lie completely within the matrix material 4 on all lateral surfaces 21. Thus, the fibers 5 lie entirely under the surface forming the respective lateral surface 21.

On the end surface it can be seen that the fibers 5 are arranged unidirectionally in the longitudinal direction in the matrix material 4. The fibers 5 shown are designed continuously. In the example shown, the total fiber volume content is in the range of 20% to 70% based on the volume of the carrier layer 2.

The adhesive layer 3 can basically be designed to be thermosetting or cold-setting, whereby it is selected from the groups consisting of polymerization, polyaddition and polycondensation adhesives, solvent-containing adhesives, dispersion adhesives, hot-melt adhesives, contact adhesives or plastisols. For the example shown, the adhesive can be an epoxy, hot-melt or polyurethane adhesive. The adhesive layer 3 has a thickness in the range of 0.01 mm to 2 mm, whereby the thickness shown does not correspond to the real dimension.

In the example shown, an additional layer (not shown) composed of metal, ceramic or plastic can be applied to carrier layer 2, for example on the lateral surface 21 forming the surface.

FIG. 2 is a cross-sectional view of the adhesive tape 1 according to FIG. 1, showing the end surface of adhesive tape section 1. The carrier layer 2 has fibers 5 arranged in a matrix material 4. An adhesive layer 3 is arranged below adjoining to the matrix material 4.

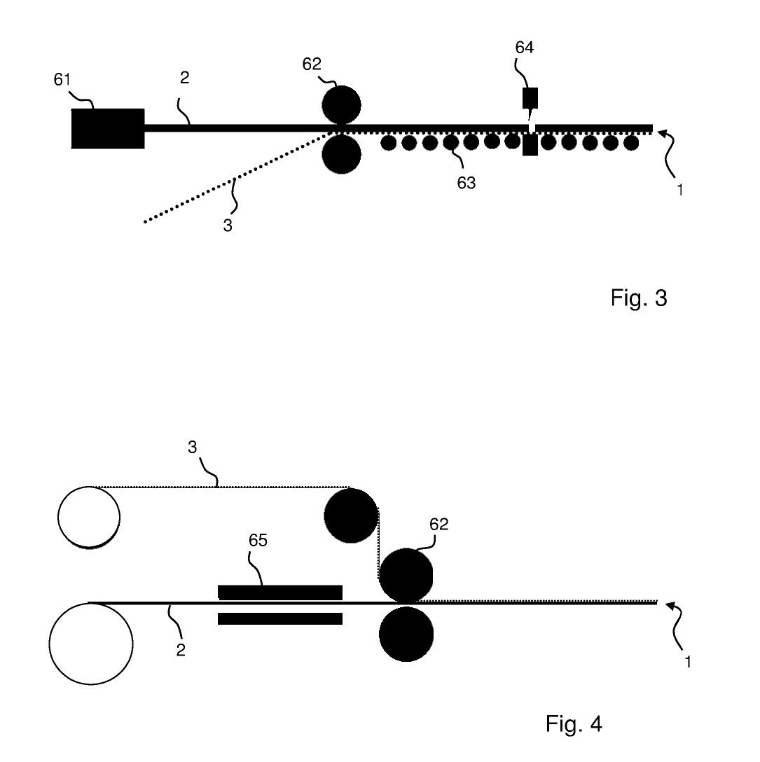

FIG. 3 is a schematic representation of a manufacturing process used to produce an adhesive tape according to FIG. 1. In this process, in an extrusion line 61, for example, the carrier layer 2 is produced from matrix material (not shown) and fibers (not shown). The adhesive layer 3 is supplied to the carrier layer 2 before the layers are supplied jointly through a roller press 62. The adhesive tape 1 is supplied via a roller unit 63 to a cutting unit 64.

FIG. 4 is a schematic representation of an alternative manufacturing process for an adhesive tape according to FIG. 1. In this process, the carrier layer 2 is provided as rolled material. In this example, the carrier layer 2 is heated in a heating device 65 and then the adhesive layer 3 is supplied thereto before the layers are supplied jointly through a roller press 62. In both production variants, the adhesive tape must be (completely) cured in order to establish the full strength of the attachment to the substrate.

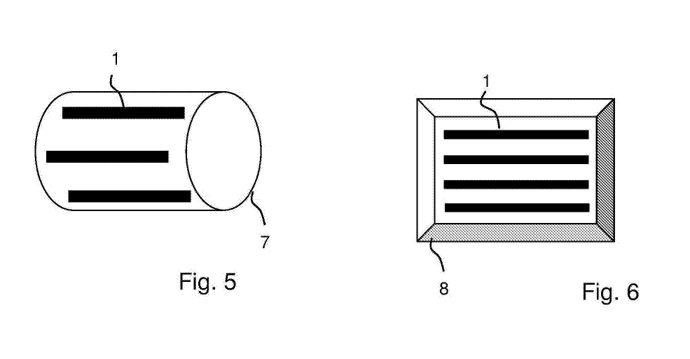

FIG. 5 is an application example for an adhesive tape 1 according to FIG. 1 on a medical support 7 and FIG. 6 is another application example for an adhesive tape 1 according to FIG. 1 in the form of an attachment to a transport box 8. In both application cases the adhesive tape 1 serves as reinforcement. The examples shown can be combined with the entire disclosure.

What is claimed is:

1. An adhesive tape for attaching, covering and mechanically reinforcing surfaces, the adhesive tape having a carrier layer and an adhesive layer adhering to the carrier layer, wherein the carrier layer is of a matrix material in which fibers are embedded.

2. The adhesive tape according to claim 1, wherein the fibers are embedded in the matrix material such that on at least one lateral surface of the fibers are located entirely under the surface of the matrix material of the carrier layer.

3. The adhesive tape according to claim 1, wherein the fibers are arranged unidirectionally in the matrix material and wherein the fibers comprise continuous or discontinuous fibers.

4. The adhesive tape according to claim 1, wherein the fibers have a fiber volume content of 15% to 80% based on the volume of the carrier layer.

5. The adhesive tape according to claim 1, wherein the fibers are of a modulus of elasticity in the range of 10 GPa to 1000 GPa.

6. The adhesive tape according to claim 1, wherein the fibers are of a tensile strength in the range of 50 MPa to 10000 MPa.

7. The adhesive tape according to claim 1, wherein the matrix material comprises voids, and wherein the volume fraction of the voids is 10% at a maximum.

8. The adhesive tape according to claim 1, wherein each fiber is of natural or synthetic polymers or inorganic materials.

9. The adhesive tape according to claim 1, wherein the matrix material comprises a thermoplastic, a thermoset, an elastomer or a thermoplastic elastomer.

10. The adhesive tape according to claim 1, wherein the carrier layer is of a thickness in the range of 0.1 mm to 7 mm.

11. The adhesive tape according to claim 1, wherein the carrier layer is of a width of 6 mm to 2000 mm.

12. The adhesive tape according to claim 1, wherein the adhesive layer is of a thickness in the range of 0.01 mm to 2 mm.

13. The adhesive tape according to claim 1, wherein the adhesive layer is selected from the groups consisting of polymerization, polyaddition and polycondensation adhesives, solvent-containing adhesives, dispersion adhesives, hot-melt adhesives, contact adhesives, or plastisols, in particular epoxy or polyurethane adhesives, phenol-formaldehyde resin adhesives or silicones, methyl-methacrylate adhesives, cyanoacrylate adhesives, anaerobic-curing adhesives or combinations thereof are used.

14. The adhesive tape according to claim 1, wherein the adhesive layer is selected from the group consisting of thermoplastic hot-melt adhesives, such as ethylene-vinyl-acetate copolymers (EVA), thermoplastic rubbers (TK), synthetic rubbers (SBS/SIS), polyester (PET), polyester (PES), polyamides (PA), polyolefins (PO), amorphous poly-α-olefins (APAO), the group consisting of reactive or encapsulated hot-melt adhesives (e.g. by UV, humidity, temperature), such as polyurethane hot-melt adhesives (PUR), polyolefin hot-melt adhesives (POR), acrylates, silane-terminated hot-melt adhesives, epoxies with thermoplastic character, silicones with thermoplastic character as well as the group consisting of hot-melt adhesives or elastomers having permanent adhesiveness, such as ethylene-vinyl-acetate copolymers (EVA), thermoplastic rubbers (TK), synthetic rubbers (SBS/SIS), polyester (PET), polyester (PES), polyamides (PA), polyolefins (PO), amorphous poly-α-olefins (APAO) or combinations of these groups.

15. The adhesive tape according to claim 1, wherein the adhesive layer is designed so as to be thermosetting or cold-setting.
